(19) United States
(12) Patent Application Publication
(10) Pub. No.: US 2026/0266451 A1
(43) Pub. Date: Sep. 10, 2026

(54) QUICK INSTALLATION AND REMOVAL STRUCTURE FOR LUMINAIRE AND LUMINAIRE

(71) Applicant: DONGGUAN JIASHENG LIGHTING TECHNOLOGY CO., LTD., Dongguan (CN)

(72) Inventor: Chih-pin HSU, Dongguan (CN)

(73) Assignee: DONGGUAN JIASHENG LIGHTING TECHNOLOGY CO., LTD., Dongguan (CN)

(21) Appl. No.: 19/372,227

(22) Filed: Oct. 28, 2025

(30) Foreign Application Priority Data
Sep. 3, 2025 (CN) 202521899965.9

(51) Int. Cl. F21V 19/04; F21S 8/00; F21S 8/04

(52) U.S. Cl. CPC F21V 19/04; F21S 8/033; F21S 8/04

(57) ABSTRACT

A quick installation and removal structure for a luminaire and a luminaire are provided. The quick installation and removal structure includes a latching portion and a connecting portion. The latching portion is fixed to the luminaire and is movable relative to the luminaire between a first position and a second position. The connecting portion is hinged to the luminaire and is detachably connected to the latching portion. The luminaire is connected to the lamp holder via the connecting portion. When the latching portion is in the first position, the connecting portion is latched and fixed to the latching portion. When the latching portion is in the second position, the connecting portion is disengaged from the latching portion and rotated to form an angle with the luminaire, thereby providing an operating space for installation and removal of the connecting portion and the lamp holder.

### TECHNICAL FIELD

The present disclosure relates to the technical field of luminaire installation, and in particular to a quick installation and removal structure for a luminaire and a luminaire.

### BACKGROUND

During interior decoration, concealing a mounting structure of a luminaire can greatly enhance the aesthetic appearance, thereby improving the living experience of users. In the prior art, a luminaire is generally fixed to a lamp holder through a male-female engagement, and the lamp holder is fixed inside a wall panel, so as to minimize a gap between the luminaire and the wall panel, thereby achieving the effect of concealing the mounting structure. However, in this case, since the gap between the luminaire and the wall panel is relatively small, it is difficult to access the mounting structure for both installation and removal. This increases the difficulty of installing and removing the luminaire, and reduces the efficiency of installation and removal.

Therefore, the prior art needs to be further improved and developed.

### SUMMARY

In view of the deficiencies in the prior art, the present disclosure aims to provide a quick installation and removal structure for a luminaire and a luminaire to solve the problem in the prior art that a gap between a luminaire and a wall panel is small, which makes the installation and removal of the luminaire more difficult, and reduces the efficiency of installation and removal.

The present disclosure adopts the following technical solutions:

In a first aspect, the present disclosure discloses a quick installation and removal structure for a luminaire, where the luminaire is fixed to a lamp holder via the quick installation and removal structure, and the quick installation and removal structure includes:

a latching portion, where the latching portion is fixed to the luminaire and is movable relative to the luminaire between a first position and a second position;

a connecting portion, where the connecting portion is hinged to the luminaire and is detachably connected to the latching portion, and the luminaire is connected to the lamp holder via the connecting portion;

when the latching portion is in the first position, the connecting portion is latched and fixed to the latching portion. When the latching portion is in the second position, the connecting portion is disengaged from the latching portion and rotated to form an angle with the luminaire, thereby providing an operating space for installation and removal of the connecting portion and the lamp holder.

In one embodiment, the connecting portion includes:

a first end, where the first end is hinged to the luminaire;

a second end, where the second end is detachably connected to the latching portion; and when the latching portion is in the second position, the second end is disengaged from the latching portion; and

a connecting base, where the connecting base is fixed on the connecting portion and is detachably connected to the lamp holder; and the connecting base moves in synchronization with the connecting portion, facilitating the installation or removal of the luminaire to or from the lamp holder after the connecting portion forms the angle with the luminaire.

In one embodiment, the first end is provided with a pivot to achieve a hinged connection between the first end and the luminaire; and the second end is provided with a latching notch to achieve a detachable connection between the second end and the latching portion.

In one embodiment, latching teeth are formed by a protrusion inside the latching notch; and when the latching portion is in the first position, the latching teeth cooperate with the latching portion to enable the connecting portion to latch and fix to the latching portion.

In one embodiment, the quick installation and removal structure further includes a receiving groove; and the receiving groove is formed on a surface of the luminaire, the latching portion is slidably disposed at one end of the receiving groove, and the connecting portion is hinged to the other end of the receiving groove.

In one embodiment, the latching portion includes:

a body, where the body is disposed within the receiving groove and is slidable along the receiving groove between the first position and the second position;

a latching hook, where the latching hook is disposed on a side of the body facing the connecting portion, and the latching portion achieves a detachable connection with the connecting portion via the latching hook;

a return spring, where the return spring is disposed between the latching portion and the luminaire, so as to enable the latching portion to move from the second position to the first position.

In one embodiment, latching slots are formed on inner sidewalls of the receiving groove opposite the body, and two side edges of the body are latched within the latching slots, enabling the body to slide freely along the receiving groove.

In one embodiment, a limiting block is disposed in the receiving groove at a location corresponding to the second position, and when the latching portion moves to the second position, and the limiting block abuts against the latching portion, preventing further movement of the latching portion.

In one embodiment, the latching portion further includes an operating portion, where the operating portion is disposed on a side of the body distal to the connecting portion, and the operating portion protrudes from the receiving groove, facilitating movement of the latching portion from the first position to the second position.

In a second aspect, the present disclosure provides a luminaire, including the quick installation and removal structure as described in any of the above embodiments.

The present disclosure discloses a quick installation and removal structure for a luminaire and a luminaire, where the luminaire is fixed to a lamp holder via the quick installation and removal structure, and the quick installation and removal structure includes a latching portion and a connecting portion. The latching portion is fixed to the luminaire and is movable relative to the luminaire between a first position and a second position. The connecting portion is hinged to the luminaire and is detachably connected to the latching portion. The luminaire is connected to the lamp holder via the connecting portion. When the latching portion is in the first position, the connecting portion is latched and fixed to the latching portion. When the latching portion is in the second position, the connecting portion is disengaged from the latching portion and rotated to form an angle with the luminaire, thereby providing an operating space for installation and removal of the connecting portion and the lamp holder. During installation and removal of the luminaire, the present disclosure enables the connecting portion to be disengaged from the latching portion by switching a position of the latching portion, such that an angle is formed between the connecting portion and the luminaire. This provides a sufficient operating space for installing and removing the luminaire with respect to the lamp holder, thereby reducing the difficulty and improving efficiency of installation and removal of the luminaire.

### BRIEF DESCRIPTION OF THE DRAWINGS

FIG. 1 is a schematic diagram of a latching engagement between a connecting portion and a latching portion according to the present disclosure.

FIG. 2 is a schematic diagram of a latching portion being moved to a second position and separated from the connecting portion according to the present disclosure.

FIG. 3 is a schematic diagram showing the latching portion being moved to the second position and lifting the connecting portion according to the present disclosure.

FIG. 4 is a schematic diagram of the latching portion returning to a first position after a connecting portion is lifted according to the present disclosure.

FIG. 5 is an exploded view of a quick installation and removal structure and a luminaire according to the present disclosure.

FIG. 6 is an exploded view of a latching portion in a quick installation and removal structure for a luminaire according to the present disclosure.

FIG. 7 is an exploded view of a connecting portion in a quick installation and removal structure for a luminaire according to the present disclosure.

FIG. 8 is a front sectional view of a quick installation and removal structure and a luminaire with a latching portion in a first position according to the present disclosure.

FIG. 9 is a front sectional view of a quick installation and removal structure and a luminaire with a latching portion in a second position according to the present disclosure.

### DETAILED DESCRIPTIONS OF THE EMBODIMENTS

The present disclosure provides a quick installation and removal structure for a luminaire. In order to make the objectives, technical solutions, and effects of the present disclosure clearer, the present disclosure will be further described in detail below. It should be understood that the specific embodiments described herein are merely used to explain the present disclosure and are not intended to limit the present disclosure.

It should be noted that the terms “center”, “upper”, “lower”, “left”, “right”, “inner”, “outer”, “vertical”, “horizontal”, etc. indicate azimuthal or positional relations on the basis of those shown in the drawings only for ease of description of the present disclosure and for simplicity of description, and are not intended to indicate or imply that the referenced structure must have a particular orientation and be constructed in a particular orientation, and thus may not be construed as a limitation on the present disclosure.

In addition, unless otherwise specified for the articles in the context, “a/an” and “the” can generally refer to either a single or multiple instances. Under the condition that embodiments of the present disclosure involve descriptions of “first”, “second”, etc., the descriptions of “first”, “second”, etc. are for descriptive purposes only and are not to be construed as indicating or implying their relative importance or implicitly specifying the number of indicated technical features. Thus, a feature defined with “first” and “second” may explicitly or implicitly include at least one of the features. In addition, the technical solutions of the embodiments may be combined with one another, which must be based on the achievement by those of ordinary skill in the art, and when the combinations of the technical solutions contradict one another or cannot be achieved, it should be considered that the combinations of the technical solutions do not exist and do not fall within the scope of protection claimed in the present disclosure.

In the prior art, to improve the aesthetic appearance after decoration, a gap between a luminaire and a mounting wall panel is often minimized. Especially for ceiling lamps and similar types of luminaires, the mounting structure is typically located inside or on a back of the luminaire. After the luminaire is mounted together with a lamp holder adapted to the wall panel, the gap between the luminaire and the wall panel is very small, making installation or removal of the luminaire more difficult, and hindering quick installation and removal of the luminaire. To address the above problems in the prior art, the present disclosure discloses a quick installation and removal structure for a luminaire. The luminaire is fixed to a lamp holder via the quick installation and removal structure, and during installation or removal, the quick installation and removal structure provides a sufficient operating space between the luminaire and the lamp holder, thereby facilitating quick installation and removal of the luminaire by a user.

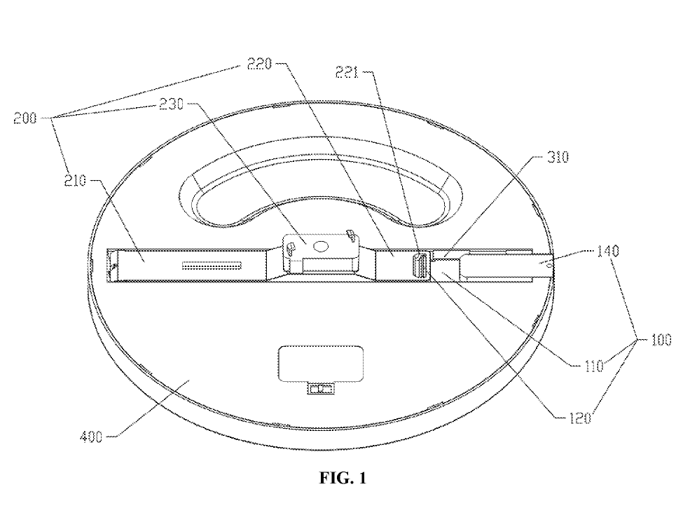

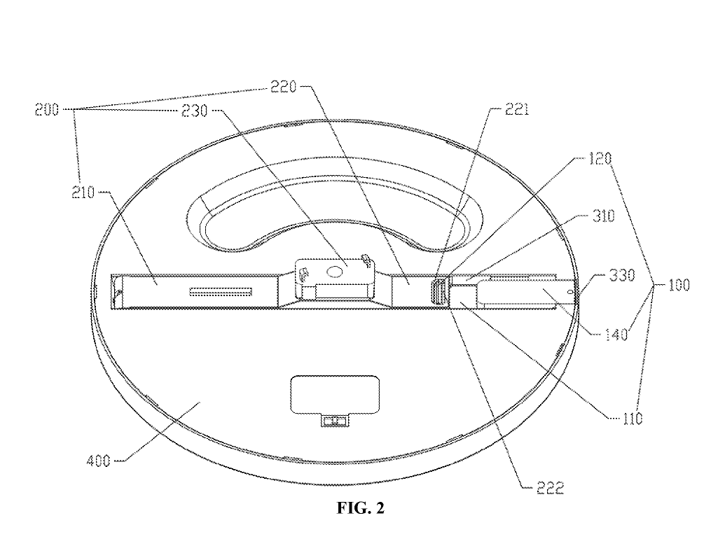

Specifically, as shown in FIGS. 1 and 2, the quick installation and removal structure includes a latching portion 100 and a connecting portion 200. The latching portion 100 is fixed to a luminaire 400 and is movable relative to the luminaire 400 between a first position and a second position. The connecting portion 200 is hinged to the luminaire 400 and is detachably connected to the latching portion 100. The luminaire 400 is connected to the lamp holder (not shown in the figures) by the connecting portion 200. When the latching portion 100 is in the first position, the connecting portion 200 is latched and fixed to the latching portion 100. When the latching portion 100 is in the second position, the connecting portion 200 is disengaged from the latching portion 100 and rotated to form an angle with the luminaire 400, thereby providing an operating space for installation and removal of the connecting portion 200 and the lamp holder. During installation and removal of the luminaire 400, the connecting portion 200 is disengaged from the latching portion 100 by switching a position of the latching portion 100, such that an angle is formed between the connecting portion 200 and the luminaire 400. This provides a sufficient operating space for installing and removing the luminaire 400 with respect to the lamp holder, thereby reducing the difficulty and improving efficiency of installation and removal of the luminaire 400.

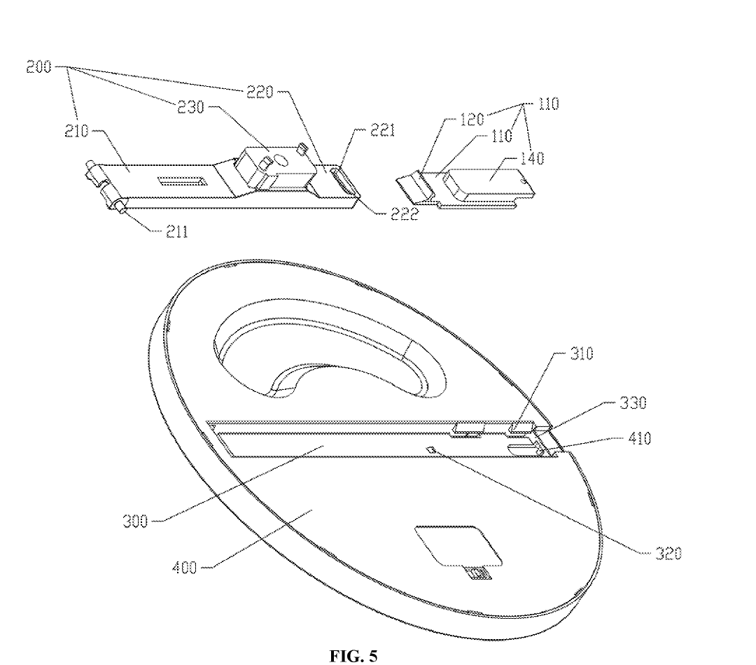

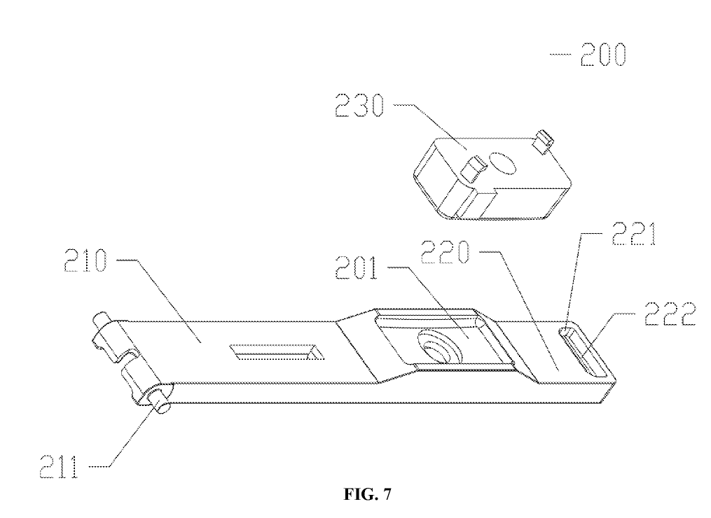

Further, as shown in FIGS. 5 and 7, the connecting portion 200 includes a first end 210, a second end 220, and a connecting base 230. The first end 210 is hinged to the luminaire 400, and the second end 220 is detachably connected to the latching portion 100. When the latching portion 100 is in the second position, the second end 220 is disengaged from the latching portion 100. The connecting base 230 is fixed on the connecting portion 200 and is detachably connected to the lamp holder (not shown in the figures). The connecting base 230 moves in synchronization with the connecting portion 200, facilitating the installation or removal of the luminaire 400 to or from the lamp holder after the connecting portion 200 forms an angle with the luminaire 400. The connecting portion 200 is hinged to the luminaire 400 via the first end 210, and is detachably connected to the latching portion 100 via the second end 220, such that the connecting portion 200 can switch between a position latched with the latching portion 100 and a position rotated to form an angle with the luminaire 400 after being disengaged from the latching portion 100. When the connecting portion 200 is disengaged from the latching portion 100, the connecting portion 200 naturally forms an angle with the luminaire 400 under gravity, thereby providing a sufficient operating space for installation and removal of the connecting portion 200 with the lamp holder, and enabling quick installation and removal of the luminaire 400 with respect to the lamp holder.

Further, as shown in FIGS. 5 and 7, the first end 210 is provided with a pivot 211 to achieve a hinged connection between the first end 210 and the luminaire 400. The second end 220 is provided with a latching notch 221 to achieve a detachable connection between the second end 220 and the latching portion 100. In this way, through a simple structural arrangement, the connecting portion 200 can achieve two connection states relative to the luminaire 400, such that the connecting portion 200 remains integrated with the luminaire 400 in a non-installation/removal state, ensuring that the luminaire 400 can closely rest against the wall panel in which the lamp holder is mounted thus concealing the mounting structure. During installation and removal, the connecting portion 200 can be rotated to a position where it maintains an angle with the luminaire 400, thereby providing a sufficient operating space for installing or removing the connecting portion 200 and the lamp holder. After completion of the installation or removal process, the connecting portion 200 is latched again with the latching portion 100 to maintain the integrated structure of the connecting portion 200 and the luminaire 400, ensuring the aesthetic appearance of the luminaire 400 after installation.

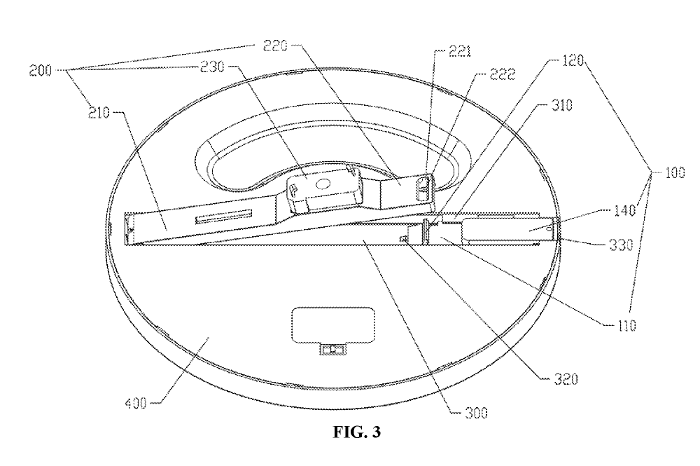

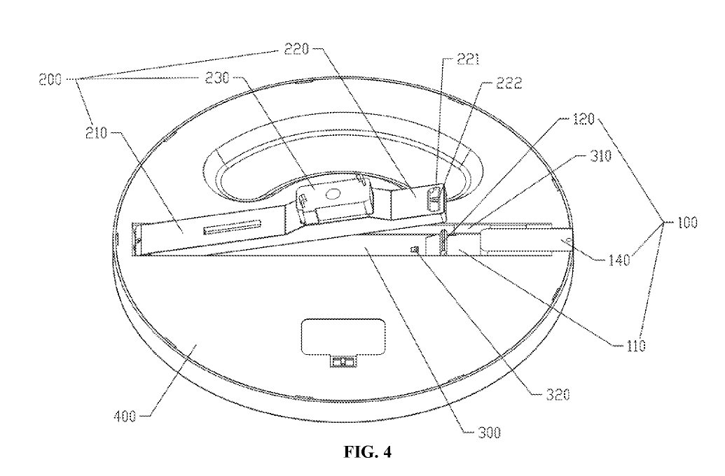

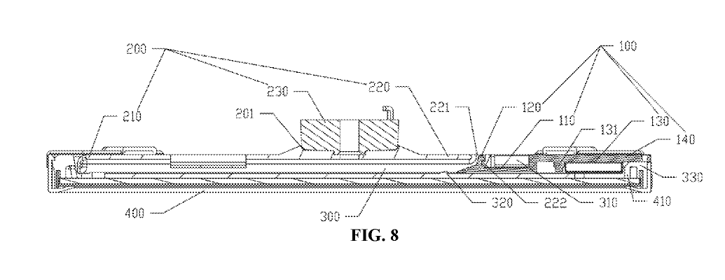

Further, as shown in FIGS. 3 and 4, latching teeth 222 are formed by a protrusion inside the latching notch 221. When the latching portion 100 is in the first position, as shown in FIG. 8, the latching teeth 222 cooperate with the latching portion 100 to enable the connecting portion 200 to latch and fix to the latching portion 100. Through the latching engagement of the latching teeth 222 with the latching portion 100, a stable latching structure is formed, thereby enhancing the stability of the connection between the connecting portion 200 and the latching portion 100. This ensures that the connecting portion 200 maintains an integrated structure with the luminaire 400 during non-installation/removal, thereby concealing the mounting structure and providing a more aesthetically pleasing installation effect for the luminaire 400.

Further, as shown in FIGS. 4 and 5, the quick installation and removal structure further includes a receiving groove 300. The receiving groove 300 is formed on a surface of the luminaire 400. The latching portion 100 is slidably disposed at one end of the receiving groove 300, and the connecting portion 200 is hinged to the other end of the receiving groove 300. The receiving groove 300 formed on the surface of the luminaire 400 is configured to receive the latching portion 100 and the connecting portion 200, thereby ensuring that the when the latching portion 100 is latched to the connecting portion 200, the latching portion 100 and the connecting portion 200 are both hidden inside the receiving groove 300, such that the luminaire 400 can be seamlessly fixed onto the wall panel, thereby providing a better visual effect for the luminaire 400.

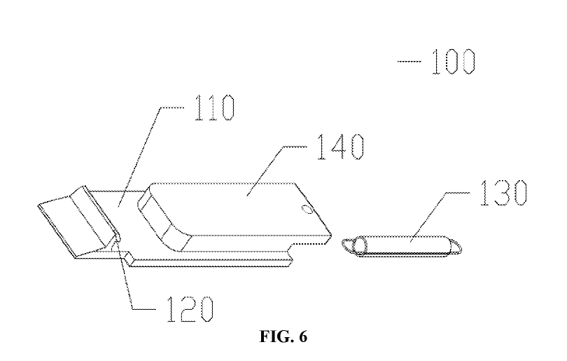

Further, as shown in FIGS. 6 and 7, the latching portion 100 includes a body 110, a latching hook 120, and a return spring 130. The body 110 is disposed within the receiving groove 300 and is slidable along the receiving groove 300 between the first position and the second position; the latching hook 120 is disposed on a side of the body 110 facing the connecting portion 200, and the latching portion 100 achieves a detachable connection with the connecting portion 200 through the latching hook 120; and the return spring 130 is disposed between the latching portion 100 and the luminaire 400, so as to allow the latching portion 100 to move from the second position to the first position. Through a stable latching structure formed by the latching hook 120 and the connecting portion 200, the latching stability between the connecting portion 200 and the latching portion 100 is enhanced, ensuring that the connecting portion 200 remains integrated with the luminaire 400 during non-installation/removal, thereby hiding the mounting structure and providing a more aesthetically pleasing installation effect for the luminaire 400. Further, the return spring 130 provides restoring force to the latching portion 100, such that when the user does not push the latching portion 100, the latching portion 100 will automatically return to the first position, thereby ensuring that the latching portion 100 remains latched to the connecting portion 200.

Further, as shown in FIGS. 3 and 4, latching slots 310 are formed on inner sidewalls of the receiving groove 300 opposite the body 110, and two side edges of the body 110 are latched within the latching slots 310, enabling the body 110 to slide freely along the receiving groove 300. The symmetrically arranged latching slots 310 cooperate with the side edges of the body 110, ensuring that the latching portion 100, when sliding within the receiving groove 300, slides stably in a longitudinal direction of the receiving groove 300, without shifting in a width direction or height direction of the receiving groove 300, thereby improving the overall structural stability.

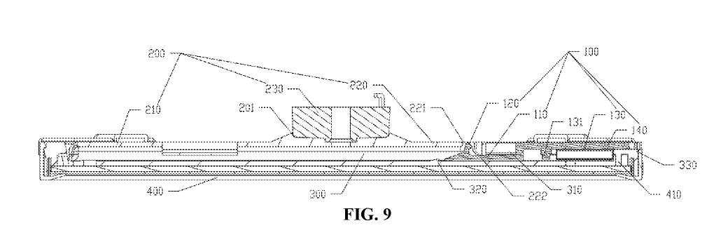

Further, as shown in FIGS. 8 and 9, a limiting block 320 is disposed in the receiving groove 300 at a location corresponding to the second position, and when the latching portion 100 moves to the second position, the limiting block 320 abuts against the latching portion 100, preventing further movement of the latching portion 100. By controlling a movement range of the latching portion 100 via the limiting block 320, it is ensured that the latching portion 100 always corresponds to the connecting portion 200, such that when the connecting portion 200 is placed and received within the receiving groove 300, a latching connection between the connecting portion 200 and the latching portion 100 can be achieved without alignment, reducing operation difficulty and improving efficiency of installation and removal.

Further, as shown in FIGS. 5, 6 and 7, the latching portion 100 further includes an operating portion 140. The operating portion 140 is disposed on a side of the body 110 distal to the connecting portion 200, and the operating portion 140 protrudes from the receiving groove 300, facilitating movement of the latching portion 100 from the first position to the second position. The operating portion 140 is engaged with an opening of the receiving groove 300 and extends to an edge of the luminaire 400, such that the user can push the operating portion 140 with a single finger, thereby driving the latching portion 100 to slide along the receiving groove 300, achieving movement of the latching portion 100 between the first position and the second position, reducing operation difficulty and improving efficiency of installation and removal.

The present disclosure further provides a luminaire, and the luminaire is equipped with the aforementioned quick installation and removal structure, thereby enabling rapid installation and removal of the luminaire. After installation, the luminaire can fit snugly against the wall panel, ensuring a visually appealing decorative effect.

The quick installation and removal structure and the luminaire equipped with the structure will be described in detail below in conjunction with specific embodiments.

In this embodiment, as shown in FIGS. 1 and 2, the luminaire 400 is a semi-flush ceiling luminaire with an overall circular shape. The quick installation and removal of the present disclosure is installed on a top of the luminaire 400, so as to fix the luminaire 400 to a ceiling.

Further, as shown in FIGS. 3 and 4, a receiving groove 300 is formed on a top of the luminaire 400 in a diameter direction, and the latching portion 100 and the connecting portion 200 are disposed at opposite ends in the receiving groove 300. Further, the receiving groove 300 is provided with a first position and a second position. In this embodiment, the first position is closer to an edge of the luminaire 400 than the second position is, that is, the second position is closer to the connecting portion 200 than the first position is. Further, the latching portion 100 is disposed between the first position and the second position, and is slidable along the receiving groove 300 between the first position and the second position.

Specifically, as shown in FIGS. 5 and 9, a limiting block 320 is formed perpendicular to a bottom of the receiving groove 300 in the second position. When the latching portion 100 moves to the second position, the latching portion 100 abuts against the limiting block 320, preventing the latching portion 100 from sliding toward the opposite end of the receiving groove 300. A baffle 330 with an opening is formed in the receiving groove 300 corresponding to the first position. When moving to the first position, the latching portion 100 abuts against the baffle 330, preventing the latching portion 100 from falling out of the receiving groove 300 and ensuring stable movement of the latching portion 100 between the first position and the second position. In addition, an opening is formed in the baffle 330 to allow the latching portion 100 to protrude from the edge of the luminaire 400, making it easier for the user to push the latching portion 100, thereby reducing the operation difficulty.

Further, as shown in FIGS. 4 and 5, the latching slots 310 are symmetrically disposed on the sidewalls of the receiving groove 300 between the first position and the second position. A width of the latching slots 310 matches a thickness of the latching portion 100, thereby securing the latching portion 100 within the latching slots 310. This ensures that the latching portion 100 can slide along the receiving groove 300 without shifting relative to a width direction or height direction of the receiving groove 300, and prevents the latching portion 100 from falling out of the receiving groove 300 during use, thereby improving the overall structural stability.

Further, as shown in FIGS. 5 and 6, the latching portion 100 includes a body 110, a latching hook 120, a return spring 130, and an operating portion 140. The body 110 is a plate, dimensions of the body 110 match the arrangement of the receiving groove 300, and a thickness of the body 110 corresponds to the arrangement of the latching slots 310, such that side edges of the body 110 can be held within the latching slots 310, allowing the body 110 to slide freely along the receiving groove 300, and ensuring that the latching portion 100 can slide freely along the receiving groove 300.

Further, as shown in FIGS. 8 and 9, the latching hook 120 is a hook structure with an opening facing away from the connecting portion 200, and cooperates with latching teeth 222 disposed at the latching notch 221 of the connecting portion 200 to form a stable latching structure between the latching portion 100 and the connecting portion 200. Therefore, when the latching portion 100 is in the first position, a stable connection between the connecting portion 200 and the latching portion 100 is achieved, fixing both the latching portion 100 and the connecting portion 200 within the receiving groove 300, and preventing the latching portion 100 or the connecting portion 200 from protruding from the receiving groove 300, thereby keeping the visual effect of the luminaire 400. Further, the latching hook 120 is provided with an inclined surface on a side facing the connecting portion 200. When the latching portion 100 moves from the first position to the second position, the latching hook 120 exerts force on the connecting portion 200 through the inclined surface to lift the connecting portion 200, facilitating the lifting of the connecting portion 200 by the user.

Further, as shown in FIGS. 8 and 9, the operating portion 140 is a hollow structure perpendicular to an upper surface of the body 110, and the operating portion 140 is disposed at a position corresponding to the opening in the baffle 330, such that that when the latching portion 100 moves to the first position, the operating portion 140 protrudes from the opening of the baffle 330, allowing the user to push the operating portion 140 by hand to drive the latching portion 100 to move from the first position to the second position.

Further, as shown in FIGS. 8 and 9, a spring post 131 is formed vertically downward inside the hollow structure of the operating portion 140. As shown in FIG. 5, the luminaire 400 is provided with a fixing post 410 at one end of the receiving groove 300 corresponding to the spring post 131. In this embodiment, one end of the return spring 130 is sleeved and fixed to the spring post 131, and the other end of the return spring 130 is sleeved and fixed to the fixing post 410, thereby fixing the return spring 130 between the latching portion 100 and the luminaire 400, providing elastic restoring force to the latching portion 100. Specifically, the return spring 130 is a tension spring. When the latching portion 100 is in the first position, the return spring 130 is in a tensioned state. After the user pushes the latching portion 100 from the first position toward the second position, the return spring 130 is in a stretched state and stores elastic force, and after the user stops applying force to the latching portion 100, the return spring 130 provides restoring force to return the latching portion 100 from the second position to the first position, thereby simplifying the control of movement of the latching portion 100 and improving operational efficiency.

Further, as shown in FIGS. 5 and 7, the first end 210 of the connecting portion 200 is provided with a pivot 211, the connecting portion 200 is hinged to one end of the receiving groove 300 via the pivot 211, and the connecting portion 200 is rotatable relative to the pivot 211, enabling the connecting portion 200 to switch between a state accommodated within the receiving groove 300 and a state forming an angle with the luminaire 400, providing an operating space for installation or removal of the luminaire 400, while ensuring the visual integrity of the luminaire 400 after installation or removal

Further, as shown in FIGS. 5 and 7, a latching notch 221 is formed on the second end 220 of the connecting portion 200, and latching teeth 222 are formed on an inner side of the latching notch 221. Specifically, dimensions of the latching notch 221 are larger than those of the latching hook 120 on the latching portion 100, and the latching teeth 222 forms a hook-shaped structure with an opening facing away from the latching portion 100, such that when the connecting portion 200 is rotated and enters the receiving groove 300, the latching teeth 222 and the latching hook 120 form a stable latching structure, ensuring a stable connection between the connecting portion 200 and the latching portion 100, and fixing the connecting portion 200 within the receiving groove 300. Further, as shown in FIGS. 8 and 9, a matching inclined surface structure is disposed at relative positions of the latching teeth 222 and the latching hook 120, such that during the rotation of the connecting portion 200 into the receiving groove 300, the latching teeth 222 interacts with the latching hook 120 to drive the latching portion 100 to move toward the connecting portion 200, thereby completing the latching engagement between the latching teeth 222 and the latching hook 120. In this way, the user does not need to make pushing operation, and the connecting portion 200 can be latched to the latching portion 100 by simply lowering the connecting portion 200 naturally into the receiving groove 300, reducing operational difficulty and improving efficiency.

Further, as shown in FIG. 7, the connecting portion 200 is provided with a fixed position 201 between the first end 210 and the second end 220, and a connecting base 230 is secured via the fixed position 201, allowing the luminaire 400 to be connected to the lamp holder via the connecting base 230. Specifically, the fixed position 201 is a recess matching a shape of the connecting base 230, securing the connecting base 230 on the connecting portion 200. A through hole is formed in the fixed position 201 to allow a power cable to pass through for supplying power to the luminaire 400. Optionally, the connecting base 230 may be a suspension device or other adapted connecting structure. The connecting portion 200 is connected to the corresponding lamp holder via the connecting base 230, thereby achieving installation and connection between the luminaire 400 and the lamp holder. Further, during installation or removal of the luminaire 400, the connecting portion 200 may be separated from the latching portion 100 and rotated to form an angle with the luminaire 400, providing a sufficient operating space for installation or removal. After the connecting base 230 is installed on or removed from the lamp holder, the connecting portion 200 is rotated until it is latched and fixed to the latching portion 100, ensuring the integrated structure of the luminaire 400 and allowing the installed luminaire 400 to fit snugly against the wall panel where the lamp holder is located, thereby ensuring the visual effect of the decoration.

The quick installation and removal structure of the present disclosure allows rapid switching between the installed and removal states through the cooperation of the connecting portion and the latching portion. In addition, in the installed or removal state, the connecting portion forms an angle with the luminaire, providing a sufficient operating space, reducing the difficulty of installation or removal, and enabling efficient quick installation and removal.

A use process of the quick installation and removal is briefly described as follows:

In the non-installation/removal state, the connecting portion and the latching portion are engaged and fully accommodated within the receiving groove, in which case, the latching portion is in the first position, and top surfaces of the connecting portion and the latching portion are flush with a top surface of the receiving groove, with only the connecting base protruding from a top of the receiving groove. To install the luminaire, a user pushes the operating portion with a finger to move the latching portion from the first position to the second position, causing the latching hook on the latching portion to disengage from the latching teeth on the connecting portion, while the latching hook lifts the connecting portion, such that the user can lift the connecting portion to form a sundial-like projection structure with the luminaire. In this way, the connecting base on the connecting portion can be installed on the lamp holder. Due to sufficient operating space, the installation is easy and can be performed rapidly. After the connecting base is installed on the lamp holder, the user lifts the luminaire, causing the luminaire to rotate relative to the connecting portion, and then places the connecting portion back into the receiving groove. The latching teeth and the latching hook cooperate to push the latching portion from the first position to the second position, and then return to the first position under the action of a return spring, completing the latching engagement between the latching teeth and the latching hook, and achieving a latching connection between the connecting portion and the latching portion. In addition, the top surfaces of the connecting portion and the latching portion remain flush with the top surface of the receiving groove, ensuring the visual effect of the luminaire after installation.

To remove the luminaire, the user similarly pushes the operating portion with a finger to move the latching portion from the first position to the second position, causing the latching hook on the latching portion to disengage from the latching teeth on the connecting portion. Upon release by the user, the latching portion returns to the first position under the force of the return spring, and the luminaire rotates relative to the connecting portion under gravity, forming an angle with the connecting portion, this provides a sufficient space for removing the connecting base from the lamp holder, making it easy for the user to quickly remove the connecting base from the lamp holder. After removal, the connecting portion is rotated back into the receiving groove, the latching teeth and the latching hook cooperate to push the latching portion from the first position to the second position, and then return to the first position under the action of a return spring, completing the latching engagement between the latching teeth and the latching hook, and achieving a latching connection between the connecting portion and the latching portion. In addition, the top surfaces of the connecting portion and the latching portion remain flush with the top surface of the receiving groove, preventing damage caused by swinging of the connecting portion during movement of the luminaire.

Therefore, the quick installation and removal structure of the present disclosure allows rapid switching between the installed and removal states through the cooperation of the connecting portion and the latching portion. In addition, in the installed or removal state, the connecting portion forms an angle with the luminaire, providing a sufficient operating space, reducing the difficulty of installation or removal, and enabling efficient quick installation and removal.

In summary, the present disclosure discloses a quick installation and removal structure for a luminaire and a luminaire, where the luminaire is fixed to a lamp holder via the quick installation and removal structure, and the quick installation and removal structure includes a latching portion and a connecting portion. The latching portion is fixed to the luminaire and is movable relative to the luminaire between a first position and a second position. The connecting portion is hinged to the luminaire and is detachably connected to the latching portion. The luminaire is connected to the lamp holder via the connecting portion. When the latching portion is in the first position, the connecting portion is latched and fixed to the latching portion. When the latching portion is in the second position, the connecting portion is disengaged from the latching portion and rotated to form an angle with the luminaire, thereby providing an operating space for installation and removal of the connecting portion and the lamp holder. During installation and removal of the luminaire, the present disclosure enables the connecting portion to be disengaged from the latching portion by switching a position of the latching portion, such that an angle is formed between the connecting portion and the luminaire. This provides a sufficient operating space for installing and removing the luminaire with respect to the lamp holder, thereby reducing the difficulty and improving efficiency of installation and removal of the luminaire.

It should be understood that the application of the present disclosure is not limited to the above examples. For those ordinarily skilled in the art, improvements or variations can be made based on the foregoing description, and all these improvements or variations shall fall within the scope of protection of the appended claims of the present disclosure.

1. A quick installation and removal structure for a luminaire, wherein the luminaire is fixed to a lamp holder via the quick installation and removal structure, and the quick installation and removal structure comprises:
a latching portion, wherein the latching portion is fixed to the luminaire and is movable relative to the luminaire between a first position and a second position;
a connecting portion, wherein the connecting portion is hinged to the luminaire and is detachably connected to the latching portion, and the luminaire is connected to the lamp holder via the connecting portion; and
when the latching portion is in the first position, the connecting portion is latched and fixed to the latching portion; and when the latching portion is in the second position, the connecting portion is disengaged from the latching portion and rotated to form an angle with the luminaire, providing an operating space for installation and removal of the connecting portion and the lamp holder.

2. The quick installation and removal structure for a luminaire according to claim 1, wherein the connecting portion comprises:
a first end, wherein the first end is hinged to the luminaire;
a second end, wherein the second end is detachably connected to the latching portion; and when the latching portion is in the second position, the second end is disengaged from the latching portion; and
a connecting base, wherein the connecting base is fixed on the connecting portion and is detachably connected to the lamp holder; and the connecting base moves in synchronization with the connecting portion, facilitating the installation or removal of the luminaire to or from the lamp holder after the connecting portion forms the angle with the luminaire.

3. The quick installation and removal structure for a luminaire according to claim 2, wherein the first end is provided with a pivot to achieve a hinged connection between the first end and the luminaire; and the second end is provided with a latching notch to achieve a detachable connection between the second end and the latching portion.

4. The quick installation and removal structure for a luminaire according to claim 3, wherein latching teeth are formed by a protrusion inside the latching notch; and when the latching portion is in the first position, the latching teeth cooperate with the latching portion to enable the connecting portion to latch and fix to the latching portion.

5. The quick installation and removal structure for a luminaire according to claim 1, further comprising a receiving groove; wherein the receiving groove is formed on a surface of the luminaire, the latching portion is slidably disposed at one end of the receiving groove, and the connecting portion is hinged to the other end of the receiving groove.

6. The quick installation and removal structure for a luminaire according to claim 5, wherein the latching portion comprises:
a body, wherein the body is disposed within the receiving groove and is slidable along the receiving groove between the first position and the second position;
a latching hook, wherein the latching hook is disposed on a side of the body facing the connecting portion, and the latching portion achieves a detachable connection with the connecting portion via the latching hook; and
a return spring, wherein the return spring is disposed between the latching portion and the luminaire to enable the latching portion to move from the second position to the first position.

7. The quick installation and removal structure for a luminaire according to claim 6, wherein latching slots are formed on inner sidewalls of the receiving groove opposite the body, and two side edges of the body are latched within the latching slots, enabling the body to slide freely along the receiving groove.

8. The quick installation and removal structure for a luminaire according to claim 6, wherein a limiting block is disposed in the receiving groove at a location corresponding to the second position; and when the latching portion moves to the second position, and the limiting block abuts against the latching portion, preventing further movement of the latching portion.

9. The quick installation and removal structure for a luminaire according to claim 6, wherein the latching portion further includes an operating portion, wherein the operating portion is disposed on a side of the body distal to the connecting portion, and the operating portion protrudes from the receiving groove, facilitating movement of the latching portion from the first position to the second position.

10. A luminaire, comprising the quick installation and removal structure for a luminaire according to claim 1.
